(19) United States
(12) Patent Application Publication
(10) Pub. No.: US 2011/0239468 A1
(43) Pub. Date: Oct. 6, 2011

(54) TRIMMER HEAD HAVING A HINGED HOUSING FOR USE IN FLEXIBLE LINE ROTARY TRIMMERS SYSTEMS

(76) Inventor: Paul Conlon, Alta Loma, CA (US)

(21) Appl. No.: 12/751,504

(22) Filed: Mar. 31, 2010

(51) Int. Cl. A01D 34/416

(52) U.S. Cl. 30/276; 30/347

(57) ABSTRACT

An invention is provided for a hinged trimmer head for use in flexible line rotary trimmer systems. The invention includes a hinged housing and cover capable of being opened to allow access to the interior of the trimmer head without risk of losing the housing parts. In addition, an open faced channel is provided is a spool that allows easy loading of cutting line. Further, a bumper button is disposed in an annular opening of the cover, providing an automated line feed mechanism and an easy cutting line spool winding mechanism.

### BACKGROUND OF THE INVENTION

1. Field of the Invention

This invention relates generally to rotary trimmer systems, and more particularly to a trimmer head having a hinged housing for use in flexible line rotary trimmer systems.

2. Description of the Related Art

As outdoor architectural and landscaping designs have increased in complexity, innovations in landscaping and maintenance techniques have improved to keep pace. Once such innovation is the flexible line rotary trimmer, which is utilized for trimming weeds, grass, and other vegetation in lawn and other landscaping maintenance. Conventional flexible line rotary trimmers generally include an attached rotatable trimmer head, which typically includes a nylon filament or “cutting line” that operates to cut grass and other vegetation when the trimmer head is rotated at high speeds.

To perform as such, the cutting line is wrapped around an interior spool, which is disposed within the trimmer head. The trimmer head generally includes opposing apertures through which the ends of the cutting line are projected. To provide rotation control, a shaft generally is attached to the trimmer head and provides rotation via an attached motor.

As the cutting line begins to wear from prolonged use, the cutting line projecting from the opposing apertures in the trimmer head tends to break off. As a result, new lengths of the cutting line wrapped around the spool are extended through the apertures in the trimmer head to replace the broken line. Depending on the type of trimmer head used, this extension of cutting line can be performed manually or semi-automatically via a line feed mechanism.

Extending the line manually generally requires the operator to detach the spool from the trimmer head. The cutting line then is manually extended by manually rotating the spool relative to the trimmer head housing to extend fresh cutting line through the apertures in the trimmer head. The spool then is reattached to the trimmer head housing to make the trimmer operational again.

In trimmer heads having a line feed mechanism, the cutting line generally is extended by temporally decoupling the spool from the trimmer housing while the trimmer is in rotation. These trimmers typically include a bump-feed type head that responds to pressure placed on the trimmer head during operation, generally by bumping a bump knob extending from the trimmer head on the ground. While pressure is applied to the trimmer head, the spool is decoupled from the trimmer housing temporarily allowing the new cutting line to extend through the apertures of the trimmer head via centrifugal force.

Eventually, as the above line feed procedures are repeated over time, the cutting line becomes fully depleted from the spool. Unfortunately, reloading new cutting line into a conventional trimmer head is a difficult and time consuming process that generally requires the trimmer head to be taken apart to access the spool and other components of the trimmer head. For example, typically the bump knob must be removed to allow a portion of the trimmer head housing to be removed allowing access the interior of the trimmer head. Next, the spool and associated spring are removed from the housing to allow new cutting line to be loaded. The cutting line then must be wrapped around the spool such that the cutting line does not release and unwind from the spool. Once fully wrapped around the spool, the ends of the cutting line generally must be fed through the apertures of the housing, while carefully ensuring the wrapped line does not unwind as mentioned above. The bump knob can then be replaced after replacing the spring and spool back into the trimmer head housing. Unfortunately, attempting to perform the above procedure in the field, often leads to lost time and lost parts as the trimmer head is disassembled in the grass, dirt, or other unsuitable location that is often offered outdoors.

In view of the foregoing, there is a need for a trimmer head that provides an easy mechanism to load new cutting line, allowing the trimmer head to be easily reloaded in the field. In addition, a mechanism is needed to assist those operating in the field from losing or misplacing parts of the trimmer head when reloading new cutting line.

### SUMMARY OF THE INVENTION

Broadly speaking, the embodiments of the present invention address these needs by providing a hinged trimmer head for use in flexible line rotary trimmer systems. Embodiments of the present invention provide a hinged housing capable of being opened to allow access to the interior of the trimmer head without risk of losing the cover. In addition, an open faced channel is provided to allow easy loading of new cutting line.

For example, in one embodiment a hinged trimmer head for use with a length of cutting line in a rotary trimmer is disclosed. The hinged trimmer head includes a housing having one or more apertures and adapted to operatively connect to a rotary trimmer to effect rotation of the trimmer head. Disposed in the housing is a spool having an open faced channel defined between two flange portions each projecting radially from a cylindrical body portion of the spool. The open faced channel can be positioned to have each end of the open faced channel near an aperture in the housing for easy loading of new cutting line.

In addition, a cover is hingably attached to the housing allowing the cover to be positioned in an open position and a closed position. The cover includes a bumper button interference fit disposed around an annular opening within the cover and protruding from an inner surface of the annular opening. Disposed in the annular opening of the cover is a bumper button. The bumper button includes a cover attachment recess disposed around a circumference of the bumper button. The bumper button interference fit on the cover is disposed in the cover attachment recess allowing the bumper button to move with respect to the cover yet remain attached. The bumper button further includes a channel insert capable of being inserted into the open faced channel when the cover is in the closed position. In general, the bumper button applies force to the spool toward housing when the bumper button is pressed.

To allow movement of the bumper button, the cover attachment recess can have a width at least twice a width of the bumper interference fit such that the bumper interference fit can move between edges of the cover attachment recess, thus allowing the bumper button to be movably attached to the cover. In addition, a plurality of posts can be included in the bumper button to allow the bumper button to drive the spool when the cover is in the closed position during loading of cutting line.

The spool can further include a plurality of indexing stops disposed on a flange of the spool. Each indexing stop can have a ramped side and a non-ramped side, wherein the indexing stops are capable of preventing the spool from allowing too much cutting line to advance. Similarly, the spool can include a plurality of cover engagement stops disposed on an opposite flange. Each cover engagement stop having a ramped side and a non-ramped side, wherein the cover engagement stops are capable of driving the spool during normal operation.

As will be appreciated by those skilled in the art with the hindsight provided by a careful reading of the present disclosure, the hinged cover of the embodiments of the present invention advantageously keeps the cover attached to the housing during loading while still allowing the hinged trimmer head to be easily loaded with cutting line. That is, attached cover mechanism prevents loss or misplacement of the cover and bumper button during reloading of cutting line, which is particularly useful when reloading cutting line in the field. In addition, the open faced channel reduces the time required to reload the trimmer with new cutting line by allowing the cutting line to be quickly dropped into the open faced channel without the need to laboriously feed and guide the cutting line through various enclosed apertures. Once the cutting line is in the channel, the cover can be closed and the bumper button used to wind the cutting line around the spool quickly and easily. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is a diagram showing an exploded view of the components of an exemplary hinged trimmer head, in accordance with an embodiment of the present invention;

FIG. 2 is a diagram showing an interior view of the housing of the hinged trimmer head, in accordance with an embodiment of the present invention;

FIG. 3 is a diagram illustrating an interior side of an exemplary cover of a hinged trimmer head, in accordance with an embodiment of the present invention;

FIG. 4 is a diagram showing an exemplary spool for carrying a coil of flexible nylon cutting line, in accordance with an embodiment of the present invention;

FIG. 5 is a diagram showing an opposing view of the exemplary spool of FIG. 4, in accordance with an embodiment of the present invention;

FIG. 6 is a diagram showing an exemplary bumper button, in accordance with an embodiment of the present invention;

FIG. 7 is a diagram showing a fully assembled hinged trimmer head in an open position, in accordance with an embodiment of the present invention; and

FIG. 8 is a diagram showing an exemplary hinged trimmer head in the closed position, in accordance with an embodiment of the present invention.

### DETAILED DESCRIPTION OF THE PREFERRED EMBODIMENTS

An invention is disclosed for a hinged trimmer head for use in flexible line rotary trimmer systems. Broadly speaking, embodiments of the present invention provide a hinged housing capable of being opened to allow access to the interior of the trimmer head without risk of losing the housing parts. In addition, an open faced channel is provided that allows easy loading of cutting line. In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

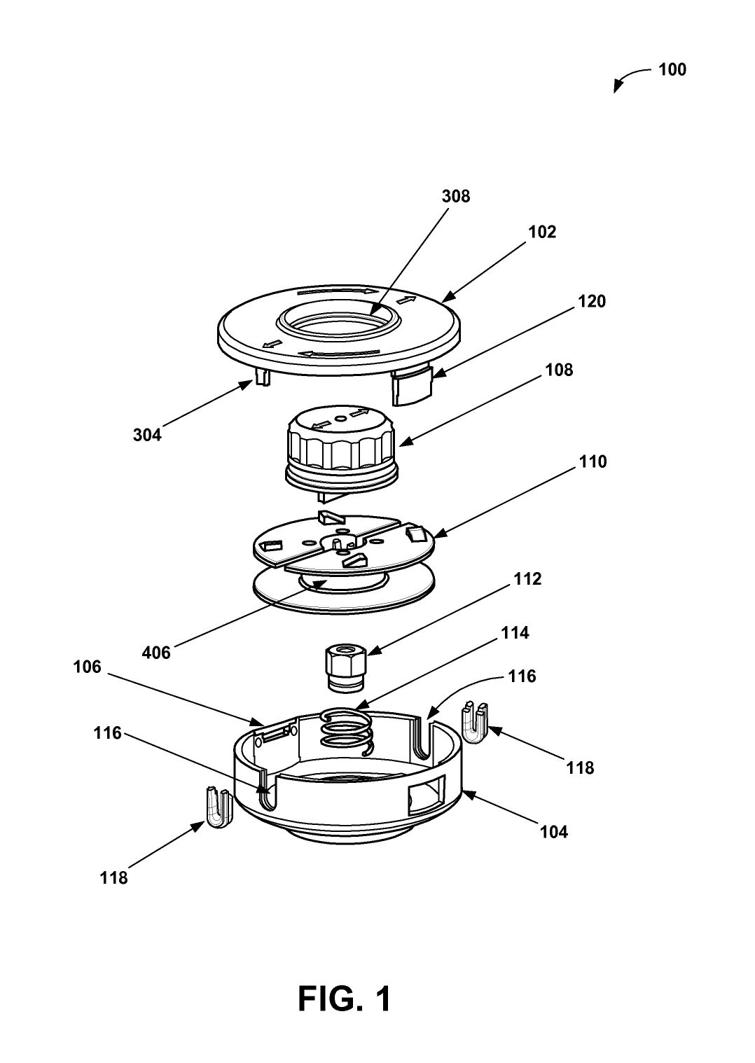

FIG. 1 is a diagram showing an exploded view of the components of an exemplary hinged trimmer head 100, in accordance with an embodiment of the present invention. The hinged trimmer head 100 generally includes a cover 102 hingedly attached to a housing 104 via a hinge 106. As will be described in greater detail subsequently, the exemplary hinge 106 illustrated in FIG. 1 can be any apparatus capable of allowing the cover 102 to be moved about the housing 104 such that the inside of the housing 104 is exposed to allow access to the interior of the hinged trimmer head 100, while keeping the cover 102 attached to the housing 104. For example, a hinge as used in the present description can be any type of element that connects the housing 104 to the cover 102 such that the housing 104 and cover 102 are allowed to rotate relative to each other about an axis of rotation. Exemplary hinges can include, a barrel hinge, a pivot hinges, a Butt/Mortise hinge, a continuous hinge, a concealed hinge, a butterfly hinge, strap hinge, a H hinge, and a HL hinge, and any other device capable of allowing the cover 102 to be moved about the housing 104 such that the inside of the housing 104 is exposed to allow access to the interior of the hinged trimmer head 100, while keeping the cover 102 attached to the housing 104.

The housing 104 also includes opposing apertures 116, each providing space for an eyelet 118 to be inserted into each aperture 116. The cover 102 also includes an attachment mechanism 120, such as the exemplary clip illustrated in FIG. 1, for securing an edge of the cover 102 to the housing 104. The hinged trimmer head 100 further includes a bumper button 108 that is generally inserted into the cover 102 and rests adjacent to a spool 110 for carrying coiled monofilament nylon cutting line. Between the spool 110 and the housing 104 is disposed a coil spring 114 and a drive bolt 112. The drive bolt 112 generally is used to mount the hinged trimmer head 100 on a extended end of a rotatable drive shaft of a powered rotary trimmer.

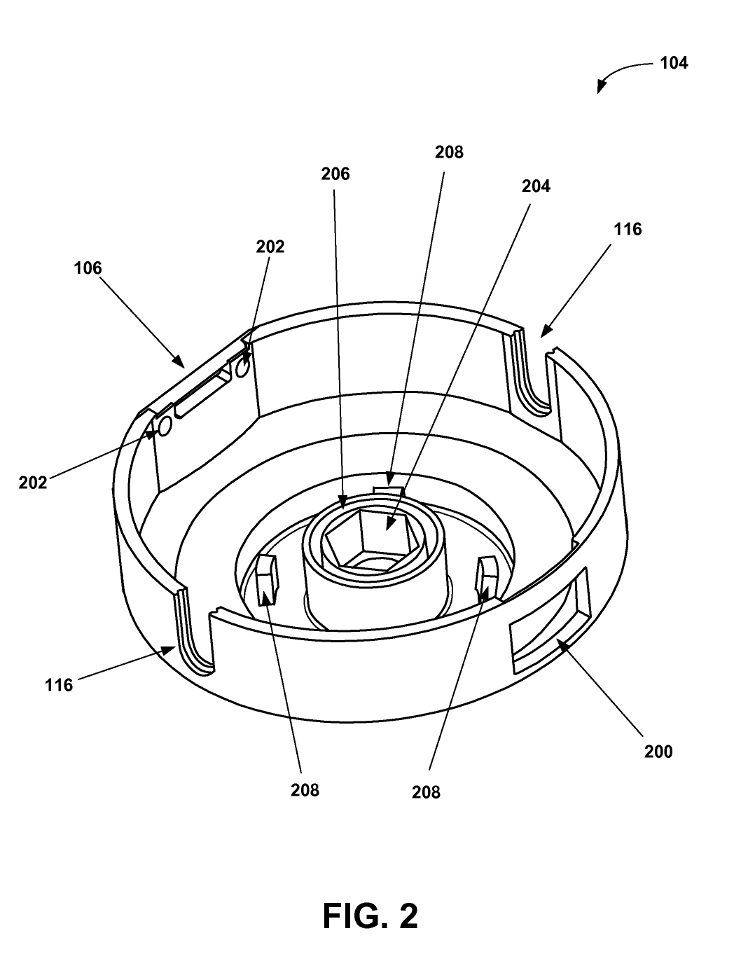

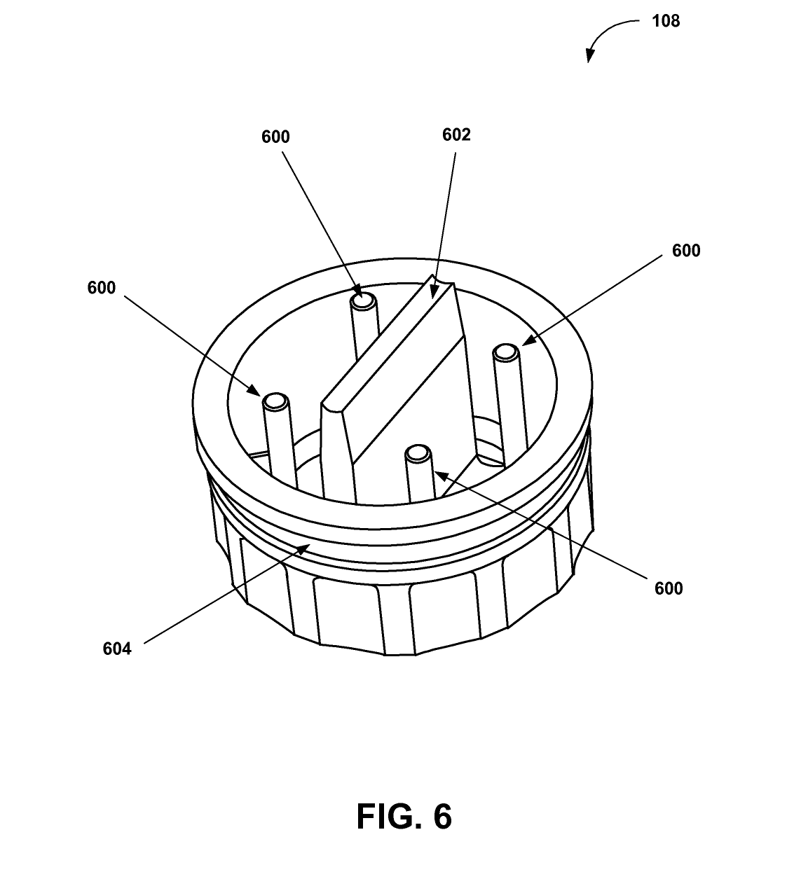

FIG. 2 is a diagram showing an interior view of the housing 104 of the hinged trimmer head, in accordance with an embodiment of the present invention. As mentioned above, the exemplary housing 104 includes a hinge 106, opposing apertures 116, and a cover attachment section 200. The exemplary hinge 106 illustrated in FIG. 6 includes a bar section for attaching the cover to the housing 104. In addition, the hinge 106 includes one or more of hinge reinforcement receptacles 202 for use in reinforcing the hinge 106 to allow the cover to remain attached during operation at high speeds, as will be described in greater detail subsequently. As noted above, the exemplary hinge 106 illustrated in FIG. 1 and FIG. 2 can be any apparatus capable of allowing the cover to be moved about the housing 104 such that the inside of the housing 104 is exposed to allow access to the interior of the hinged trimmer head, while keeping the cover attached to the housing 104.

Each opposing aperture 116 provides space for an eyelet to be inserted into each aperture 116 from which cutting line protrudes during operation to provide cutting action. The cover attachment section 200 provides an area for the cover attachment mechanism disposed on the cover to attach to the housing 104. Although the cover attachment section 200 on the housing 104 and the attachment mechanism disposed on the cover generally are positioned opposite to the hinge 106, it should be noted that these elements can be disposed in other locations relative to the hinge 106 as desired by the manufacturer.

A drive bolt receptacle 204 is formed in a centrally disposed tubular extension of the housing 104. The drive bolt receptacle 204 generally is formed to provide a close fit for the drive bolt, which is inserted into the drive bolt receptacle 204. The shaped interior surface area of the drive bolt receptacle 204, generally formed to match the outer surface of the drive bolt, assists the drive bolt to rotate the housing 104 as the drive bolt rotates in response to the rotation of the extended end of a rotatable drive shaft of a powered rotary trimmer during operation.

In addition, a spring receptacle 206 is formed in the centrally disposed tubular extension of the housing 104 adjacent to the drive bolt receptacle 204. The spring receptacle 206 is formed to allow the coil spring 114 to be inserted into the spring receptacle 206, allowing spring force to be applied to a side of the spool 110 when it is inserted into the housing 104. The housing 104 further includes housing stops 208 formed into the housing 104. The housing stops 208 provide a mechanism to prevent the spool 110 from over extending and allowing too much cutting line to advance from the spool 110 when the bumper button 108 is engaged to advance the cutting line, as will be described in greater detail below.

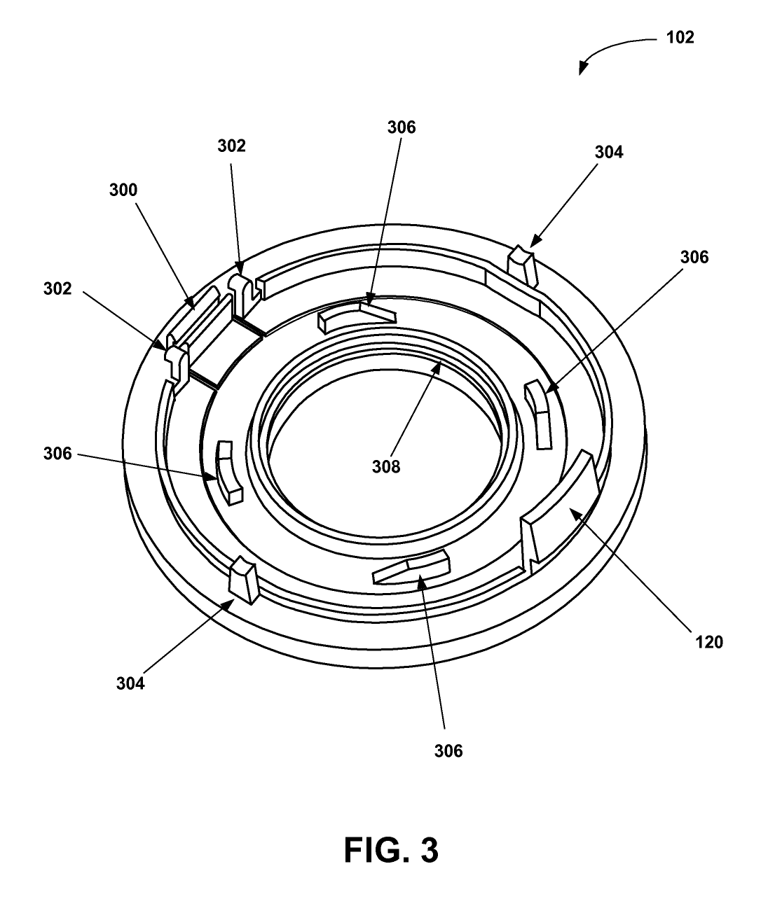

FIG. 3 is a diagram illustrating an interior side of an exemplary cover 102 of a hinged trimmer head, in accordance with an embodiment of the present invention. As illustrated in FIG. 3, the exemplary cover 102 includes a hinged section 300, a pair of hinge reinforcement bosses 302, an attachment mechanism 120, a pair of opposing eyelet inserts 304, a plurality of cover stops 306, and a bumper button interference fit 308 disposed around an annular opening within the cover 102. In general, the bumper button interference fit 308 is a protruding ring disposed around an annular opening within the cover 102 that protrudes beyond the inner surface of the annual opening.

The hinged section 300 of the exemplary cover 102 includes a hinge clip area that, in the illustrated example, fastens onto a hinge bar of hinge 106 on the housing 104. In addition, the hinge section 300 includes a pair of hinge reinforcement bosses 302 that insert into the hinge reinforcement receptacles 202 of the housing 104 when the hinged trimmer head 100 is in a closed position. In this manner, the hinge reinforcement bosses 302 strengthen the engagement of the hinge 106 when the cover 102 is closed and attached to the housing 104 via the attachment mechanism 120. However, As noted above, the exemplary hinge 106 and hinge section 300 illustrated of FIG. 1, FIG. 2, and FIG. 3 can be any apparatus capable of allowing the cover to be moved about the housing 104 such that the inside of the housing 104 is exposed to allow access to the interior of the hinged trimmer head, while keeping the cover attached is some manner to the housing 104.

In the example of FIG. 3, the attachment mechanism 120 generally clips into the cover attachment section 200 of the housing when the hinged trimmer head 100 is in a closed position. However, it should be borne in mind that any form of attachment mechanism can be utilized by the embodiments of the present invention to fasten an area of the cover 102 to the housing 104 during operation. Generally, as noted above, the attachment mechanism 120 is disposed opposite the hinge 106. However, it should be noted that the attachment mechanism 120 and attachment section can be disposed in any location of the cover 102 and/or housing 104.

The eyelet inserts 304 fit into the eyelets 118 and opposing apertures 116 of the housing 104 when the hinged trimmer head 100 is in a closed position. In this manner, the opposing apertures 116, eyelets 118, and eyelet inserts 304 form opposing small openings in the side of the housing 104 when the hinged trimmer head 100 is in a closed position. The opposing small openings allow ends of a cutting line to protrude through the sides of the housing 104 during operation, which operate to cut grass and other vegetation when the hinged trimmer head is rotated at high speeds.

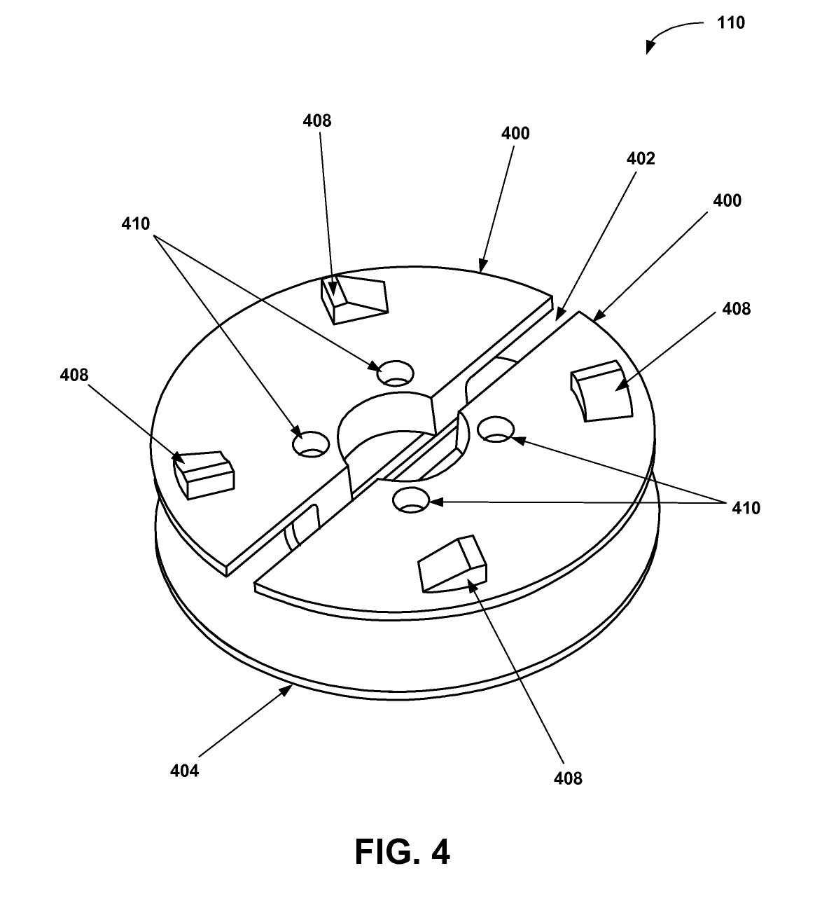

As noted above, a plurality of cover stops 306 are formed on an interior surface of the cover 102. Each cover stop 306 includes ramp section on a first side, and a non-ramped, vertical section on a second side. Preferably, each cover stop 306 includes the ramped section and a non-ramped section on the same relative side to each other. As will be described in greater detail below, the spool 110 includes a plurality of cover engagement stops, each of which including a ramped and non-ramped side formed opposite the sides of the cover stops 306. During operation, the non-ramped, vertical side of each of the cover engagement stops on the spool 110 abuts a non-ramped, vertical side of a cover stop 306, thus engaging the spool 110 with the cover 102 and allowing the spool 110 to rotate in unison with the cover 102. During line insertion, the spool 110 is manually rotated in an opposite direction of the operational rotation. Hence, during line insertion the ramped side of each of the cover engagement stops on the spool 110 periodically slides across a ramped side of a cover stop 306, thus allowing the spool to rotate independently of the cover 102, and without rotation of the cover 102, as discussed in greater detail next with reference to FIG. 4.

FIG. 4 is a diagram showing an exemplary spool 110 for carrying a coil of flexible nylon cutting line, in accordance with an embodiment of the present invention. The spool 110 includes two upper annular flange portions 400 having an open faced channel 402 defined between the two upper annular flange portions 400. The term open faced channel shall be defined as an unenclosed channel open to an outside of the spool 110 defined between two or more similarly sized or dissimilarly sized flange portions 400. Although the exemplary spool 110 of FIG. 4 illustrates a single open faced channel, it should be noted that multiple open faced channels can be included, each defined between two or more similarly sized or dissimilarly sized flange portions 400.

In addition, the spool 110 includes a lower annular flange 404. Connecting the two upper annular flange portions 400 and the lower annular flange 404 is a hollow cylindrical body portion 406 (see FIG. 1). The hollow cylindrical body portion 406 functions to carry a coil of flexible nylon cutting line wrapped about the hollow cylindrical body portion 406 such that end portions of the cutting line extend outward through the eyelets 118 and opposing apertures 116 of the housing 104. The spool 110 further includes a plurality of cover engagement stops 408 disposed in the upper annular flange portions 400. As illustrated in FIG. 4, each cover engagement stop 408 includes a ramped side and a non-ramped side for driving the spool 110 during normal operation. Further, a plurality of bumper button post receptors 410 are disposed in the upper annular flange portions 400 for driving spool 110 rotation during manual line loading of the spool 110, as will be discussed in greater detail subsequently.

As mentioned previously, cover engagement stops 408 are formed on a surface of the upper annular flange portions 400 to drive the spool 110 during normal operation. More specifically, during normal operation, the coil spring 114 pushes against the spool 110 toward the hinged trimmer head cover 102. As a result, the non-ramped side of each of the cover engagement stops 408 abuts a non-ramped side of a cover stop 306 on the cover 102, thus engaging the spool 110 with the cover 102 and allowing the spool 110 to rotate in unison with the cover 102. When the bumper button 108 is depressed, for example by bumping the bumper button 108 on the ground, the bumper button 108 applies force to the spool 110 toward the housing 104. In response, the coil spring 114 compresses and allows the spool 110 to move toward the housing 104, thus temporarily disengaging the cover engagement stops 408 from the cover stops 306, and allowing the spool 110 to rotate independently of the cover 102. The temporary disengagement allows facilitate new cutting line to extend through the apertures 116 of the hinged trimmer head 100.

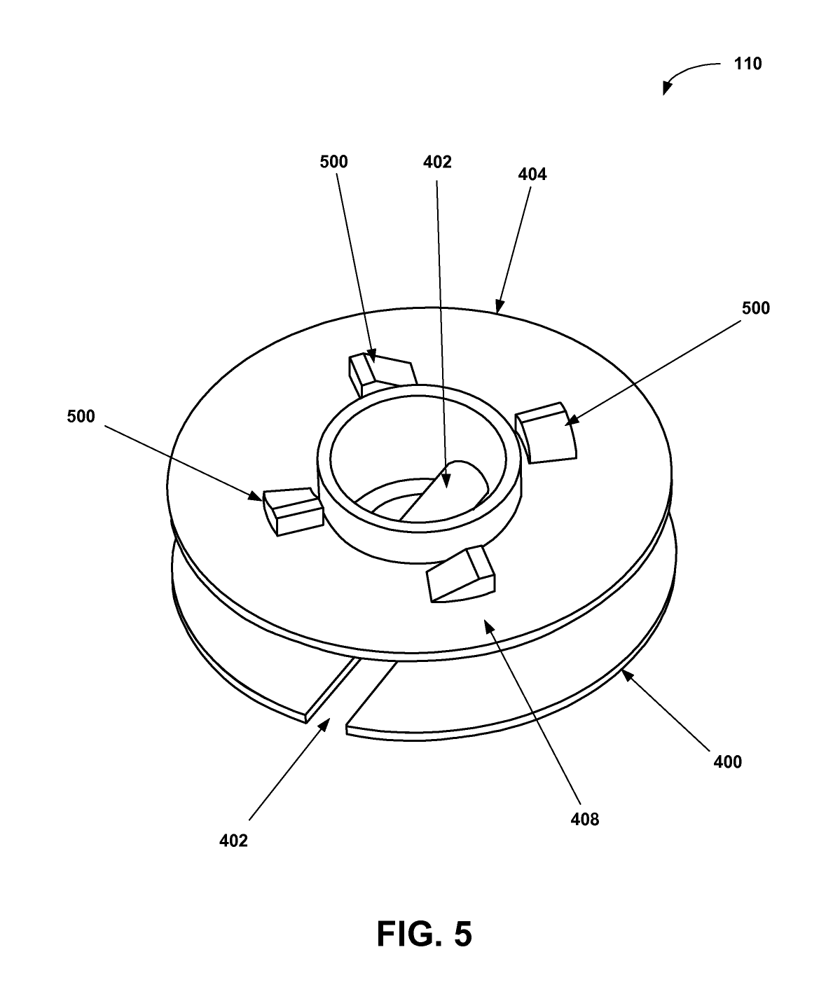

To prevent the cutting line from overextending through the apertures 116, the spool 110 includes indexing stops 500, as illustrated in FIG. 5. FIG. 5 is a diagram showing an opposing view of the exemplary spool 110 of FIG. 4, in accordance with an embodiment of the present invention. Similar to the cover engagement stops 408, each indexing stop 500 includes a ramped side and a non-ramped, vertical side. The indexing stops 500 function to prevent the spool 110 from over extending and allowing too much cutting line to advance from the spool 110 when the bumper button 108 is engaged to advance the cutting line. As mentioned above, the housing 104 includes a plurality of housing stops 208 formed into the housing 104. As the spool 110 is pushed toward the housing 104 to advance the cutting line, the non-ramped sides of the indexing stops 500 on the spool 110 eventually abut the non-ramped sides of the housing stops 208 on the housing, thus engaging the spool 110 with the housing 104, thus causing the spool to rotate in unison with the housing 104. As a result, the spool 110 is prevented from further independent rotation, thus stopping further extending of the cutting line through the housing apertures.

Eventually, as the above line feed procedures are repeated over time, the cutting line becomes fully depleted from the spool. Referring back to FIG. 4, embodiments of the present invention provide an efficient manner in which to load new cutting line into the hinged trimmer head via the open faced channel 402 and open apertures 116 and eyelets 118 of the housing 104. As will be described in greater detail subsequently, the open faced channel 402 allows a length of cutting line to be laid into to the open faced channel 402 without requiring the line to be threaded through small openings. Once the line is laid into the open faced channel 402, the cover 102 is placed in the closed position, and the bumper button 108 is rotated in a direction opposite the operational rotation to wind the cutting line around the spool.

FIG. 6 is a diagram showing an exemplary bumper button 108, in accordance with an embodiment of the present invention. The bumper button 108 includes a plurality of posts 600, a channel insert 602, and a cover attachment recess 604. As mentioned above, the bumper button 108 is utilized to extend new cutting line from the spool 110 during operation of the hinged trimmer head. In addition, as will be described in greater detail subsequently, the bumper button 108 is utilized to facilitate manual loading of additional cutting line. When assembled, the bumper button 108 is inserted into the annular opening in the cover 102 until the bumper button interference fit 308 on the cover 102 is situated within the cover attachment recess 604 of the bumper button 108. The cover attachment recess 604 allows the bumper button 108 to move in directions perpendicular to the surface of the cover 102 a distance approximately equal to the width of the cover attachment recess 604. That is, when the bumper button interference fit 308 reaches an edge of the cover attachment recess 604, the bumper button 108 is prevented from moving further in that particular direction unless additional force is used to pop the bumper button interference fit 308 over the edge of the cover attachment recess 604. Although the embodiments described thus far illustrate the bumper button interference fit 308 being located on the cover 102 and the cover attachment recess 604 being located on the bumper button 108, it should be noted that these elements can be reversed such that the bumper button interference fit 308 is located on the bumper button 108 and the cover attachment recess 604 is located on the cover 102.

During normal operation, the bumper button 108 stays attached to the cover 102 and is able to move perpendicular to the cover 102 a distance approximately equal to the width of the cover attachment recess 604. Hence, when the bumper button 108 is depressed, for example by bumping the bumper button 108 on the ground, the bumper button 108 applies force to the spool 110 toward the housing 104 and allows additional cutting line to be extend through the apertures in the hinged trimmer head 100 as described above. Generally, the bumper button 108 is prevented from detaching from the cover 102 because the bumper button 108 is prevented from moving further in a particular direction when the bumper button interference fit 308 on the cover 102 reaches an edge of the cover attachment recess 604 on the bumper button 108. Yet, to allow for maintenance and replacement for the hinged trimmer head 100 and it's components, the bumper button 108 can be detached from the cover 102 by applying additional force to pop the bumper button interference fit 308 over the edge of the cover attachment recess 604 and release the bumper button 108 from the cover 102.

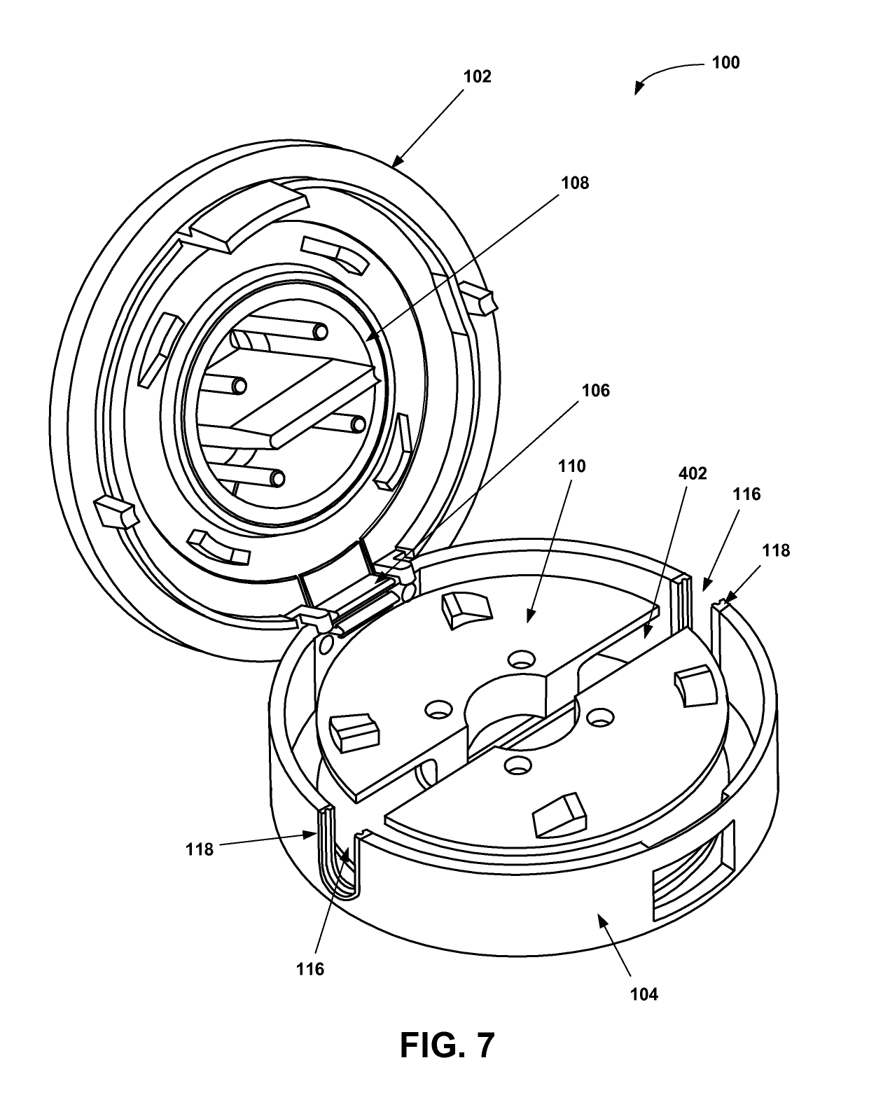

FIG. 7 is a diagram showing a fully assembled hinged trimmer head 100 in an open position, in accordance with an embodiment of the present invention. When assembled, the hinged trimmer head 100 includes a cover 102 attached to the housing 104 via a hinged apparatus 106. Disposed in the cover is the bumper button 108, generally held in place via the bumper button interference fit 308 formed the cover 102 and positioned within the cover attachment recess 604 on the bumper button 108. Positioned within the housing 104 is the spool 110, which is disposed above the drive bolt 112 and coil spring 114 (as illustrated in FIG. 1).

FIG. 7 illustrates the hinged trimmer head 100 in an open position ready for manual loading of cutting line. More specifically, cutting line is loaded into the hinged trimmer head 100 by placing the hinged trimmer head 100 in the open position by opening the cover 102 about the hinge 106, as illustrated in FIG. 7. Advantageously, the hinge 106 keeps the cover 102 attached to the housing 104 during loading while still allowing the hinged trimmer head 100 to be easily loaded with cutting line. The attached cover mechanism prevents loss or misplacement of the cover 102 and bumper button 108 during reloading of cutting line, which is particularly useful when reloading cutting line in the field.

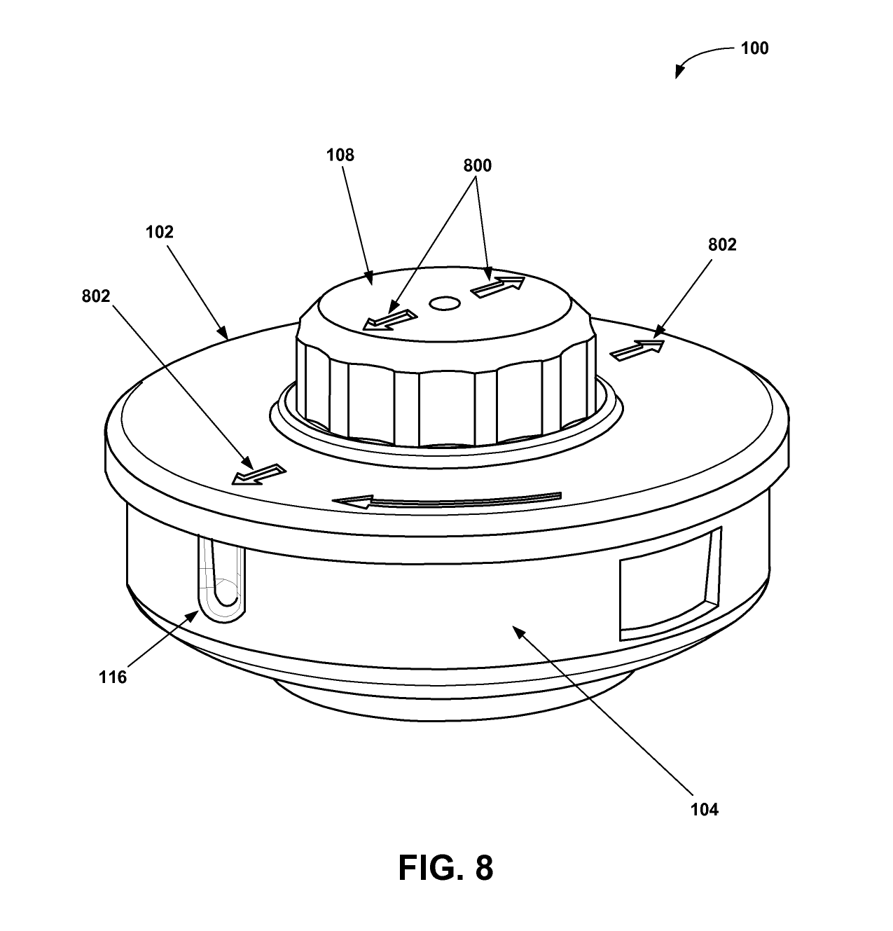

Once the hinged trimmer head 100 is placed in the open position, as illustrated in FIG. 7, the open faced channel 402 is aligned such that the ends of the open faced channel 402 are aligned with the apertures 116 and eyelets 118 of the housing 104. In actual use, this alignment can occur prior to opening the hinged trimmer head 100 by aligning channel alignment marks 800 on the bumper button 108 with aperture indication marks 802 on the cover 102, as illustrated in FIG. 8.

Once aligned, a length of new cutting line is inserted into the open faced channel 402 and across the eyelets 118 in the apertures 116 of the housing 104. For example, the middle of a length of cutting line can be placed on near the center of the spool 110 when the cutting line is inserted into the open faced channel 402, while the remainder of the cutting line lies across the eyelets 118 and initially outside the housing 104. Thereafter, the hinged trimmer head is placed in the closed position by closing the cover 102 on the housing 104 and attaching the attachment mechanism 120 on the cover 102 with the cover attachment section 200 of the housing 104 as illustrated in FIG. 8. When closing the cover 102, the posts 600 of the bumper button 108 insert into the bumper button post receptors 410 on the spool 110. In addition, the channel insert 602 of the bumper button 108 inserts into the open faced channel 402 of the spool 110. The posts 600 and channel insert 602 of the bumper button 108 thus provide a means to drive the spool 110 during line loading, and further assist in holding the cutting line in the open faced channel 402 during normal operation.

FIG. 8 is a diagram showing an exemplary hinged trimmer head 100 in the closed position, in accordance with an embodiment of the present invention. More specifically, FIG. 8 illustrates an exemplary hinged trimmer head 100, just prior to loading new cutting line, and just after new cutting line has been inserted into the open faced channel 402 of the spool 110 and the cover 102 closed. As mentioned above, prior to loading new cutting line into the hinged trimmer head 100, an operator can align the channel alignment marks 800 on the bumper button 108 with the aperture indication marks 802 of the cover 102. The channel alignment marks 800 on the bumper button 108 show the alignment of the channel insert 602 of the bumper button 108. Because the channel insert 602 is inserted into the open faced channel 402 of the spool 110 when the cover 102 is in the closed position, the channel alignment marks 800 also show the alignment of the open faced channel 402 of the spool. The aperture indication marks 802 on the cover 102 align with the apertures 116 of the housing 104 when the cover 102 is in the closed position. Thus, when hinged trimmer head 100 is in the closed position and the channel alignment marks 800 on the bumper button 108 are aligned with the aperture indication marks 802 of the cover 102, the ends of the open faced channel 402 of the spool 110 are aligned with the apertures 116 and eyelets 118 of the hosing 104 and the hinged trimmer head 100 is ready for loading, as described above.

Once a length of cutting line is inserted into the open faced channel 402 of the spool 110 and the cover 102 is placed in the closed position, as described above, the channel alignment marks 800 initially generally align with the aperture indication marks 802. To continue the cutting line loading process, bumper button 108 is rotated in a direction opposite to the direction of spool rotation during normal operation. As noted above, the posts 600 and channel insert 602 drive the spool 110 during manual rotation, and thus the spool 110 rotates and the same rate and direction as the bumper button 108 during loading of the cutting line. As a result, cutting line located outside the housing 104 is wound around the center area of the spool 110 as the bumper button 108 is rotated. Rotation of the bumper button 108 can be stopped when the ends of the newly loaded cutting line remaining outside the housing 104 are of sufficiently short length.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A hinged trimmer head for use with a length of cutting line in a rotary trimmer, comprising:
a housing adapted to operatively connect to a rotary trimmer to effect rotation of the trimmer head, the housing having one or more apertures;
a spool disposed within the housing, the spool having at least one open faced channel defined between at least two flange portions each projecting radially from a cylindrical body portion of the spool, wherein the open faced channel can be positioned to have each end of the open faced channel near an aperture in the housing; and
a cover hingedly attached to the housing, wherein the cover can be positioned in an open position and a closed position.

2. A hinged trimmer head as recited in claim 1, further comprising a bumper button disposed in the cover, the bumper button capable of applying force to the spool toward housing when the bumper button is pressed.

3. A hinged trimmer head as recited in claim 2, wherein the bumper button includes a cover attachment recess disposed around a circumference of the bumper button, the a cover attachment recess allowing the bumper button to be movably attached to the cover.

4. A hinged trimmer head as recited in claim 2, wherein the bumper button includes a plurality of posts capable of driving the spool, and wherein the bumper button includes a channel insert capable of being inserted into the open faced channel when the cover is in the closed position.

5. A hinged trimmer head as recited in claim 1, wherein the spool further includes a plurality of indexing stops disposed on a flange of the spool, each indexing stop having a ramped side and a non-ramped side, wherein the indexing stops are capable of preventing the spool from allowing too much cutting line to advance.

6. A hinged trimmer head as recited in claim 4, wherein the spool further includes a plurality of cover engagement stops disposed on an opposite flange, each cover engagement stop having a ramped side and a non-ramped side, wherein the cover engagement stops are capable of driving the spool during normal operation.

7. A hinged trimmer head for use with a length of cutting line in a rotary trimmer, comprising:
a housing adapted to operatively connect to a rotary trimmer to effect rotation of the trimmer head, the housing having one or more apertures;
a spool disposed within the housing, the spool having at least one open faced channel defined between at least two flange portions each projecting radially from a cylindrical body portion of the spool, wherein the open faced channel can be positioned to have each end of the open faced channel near an aperture in the housing;
a cover hingably attached to the housing, wherein the cover can be positioned in an open position and a closed position; and
a bumper button removably attached to the cover, the bumper button including a channel insert capable of being inserted into the open faced channel when the cover is in the closed position, wherein the bumper button applies force to the spool toward housing when the bumper button is pressed.

8. A hinged trimmer head as recited in claim 7, wherein the cover includes a bumper button interference fit disposed around an annular opening within the cover, the bumper button interference fit protruding from an inner surface of the annular opening, and wherein the bumper button includes a cover attachment recess disposed around a circumference of the bumper button, wherein the bumper button interference fit is disposed in the cover attachment recess.

9. A hinged trimmer head as recited in claim 7, wherein the cover attachment recess has a width at least twice a width of the bumper interference fit such that the bumper interference fit can move between edges of the cover attachment recess, whereby the bumper button to be movably attached to the cover.

10. A hinged trimmer head as recited in claim 7, wherein the bumper button includes a plurality of posts capable of driving the spool when the cover is in the closed position during loading of cutting line.

11. A hinged trimmer head as recited in claim 7, wherein the spool further includes a plurality of indexing stops disposed on a flange of the spool, each indexing stop having a ramped side and a non-ramped side, wherein the indexing stops are capable of preventing the spool from allowing too much cutting line to advance.

12. A hinged trimmer head as recited in claim 11, wherein the spool further includes a plurality of cover engagement stops disposed on an opposite flange, each cover engagement stop having a ramped side and a non-ramped side, wherein the cover engagement stops are capable of driving the spool during normal operation.

13. A hinged trimmer head as recited in claim 7, wherein each aperture extends to an end of the housing and is open to the cover when the cover is in the closed position.

14. A hinged trimmer head as recited in claim 7, further comprising a coil spring disposed between the housing and the spool, wherein the coil spring applies force to the spool in the direction of the cover when the cover is in the closed position.
